(19) United States
(12) Patent Application Publication
(10) Pub. No.: US 2016/0263954 A1
(43) Pub. Date: Sep. 15, 2016

(54) VALVE STEM CORE MODULE

(71) Applicant: RIM MASTER INDUSTRIAL CO., LTD, Tainan City (TW)

(72) Inventor: I-Huang CHANG, TAINAN CITY (TW)

(21) Appl. No.: 14/645,180

(22) Filed: Mar. 11, 2015

(51) Int. Cl. B60C 29/00; F16K 31/60

(52) U.S. Cl. CPC B60C 29/005; F16K 31/60

(57) ABSTRACT

A valve stem core module has a core tube and a core pin. The core tube has a tube body and an airtight ring. The tube body has a mid segment located between two ends of the tube body. The mid segment matches a specification of 5V1 thread. The tube body further has a body space longitudinally formed through the tube body. The airtight ring is hermetically mounted around an outer side of one of the ends of the tube body. The core pin has a pin body inserted into the body space. The pin body further has a closing ring hermetically mounted around the pin body. The pin body further has a fixing nut combined with the pin body, protruding out of the tube body, such that the closing ring is hermetically closed on the tube body.

### BACKGROUND OF THE INVENTION

1. Field of the Invention

The present invention relates to a valve stem, and more particularly to a valve stem core module.

2. Description of Related Art

Valve stems over the world are developed and differ from country to country. Generally, a German valve stem, a Dunlop valve stem, a French valve stem and a Schrader valve stem are common valve stems. The French valve stem comprises a core module. The core module comprises a body and a nut mounted on the body. When the nut is tightened, an airtight ring of the body can hermetically abut a tapered surface of the body to keep from leak, such that the French valve stem can be applied for a high pressure tire. An intake air amount for the tire can be controlled by the French valve stem. The Schrader valve stem comprises a specification of 5V1 thread in an inner hole of a tube body of the Schrader valve stem, such that an outer diameter of the tube body is relatively large and a thickness of a side wall of the tube body is relatively thick. Therefore, the Schrader valve stem has high strength.

However, in the French valve stem, an elongated tube body is directly fixed on the core module since the French valve stem is designed for the high pressure tire. A thickness of the side wall of the tube body is relatively thin, such that a strength of the French valve stem may be insufficient. If the French valve stem is impacted by a force, the tube body may be fractured. Furthermore, nozzles of inflators in Europe are French nozzles, and the French nozzles are applied for the French valve stem or a British valve stem and not for the Schrader valve stem. The Schrader valve stem is not applicable on the high pressure tire. The core module of the Schrader valve stem comprises a spring, and problems such as fracture, deformation, elastic fatigue, and blocking occur on the spring, such that a leak proof performance for the Schrader valve stem may be affected. Therefore, the tire may be deflated easily, and a life time of the Schrader valve stem may be decreased.

### SUMMARY OF THE INVENTION

The main objective of the present invention is to provide a valve stem core module to resolve the afore-mentioned problems.

The valve stem core module comprises a core tube and a core pin.

The core tube comprises a tube body and an airtight ring. The tube body comprises a first end. A thread is formed on an outer side of the first end. The tube body further comprises a second end opposite to the first end, a mid segment located between the first end and the second end, and a thread formed on an outer side of the mid segment. The thread of the mid segment matches a specification of 5V1 thread. The tube body further comprises a body space longitudinally formed through the tube body. The airtight ring is hermetically mounted around an outer side of the second end.

The core pin comprises a pin body inserted into the body space and comprising a threaded segment and a positioning portion. The pin body further comprises a closing ring hermetically mounted around the positioning portion and a fixing nut. The fixing nut is combined with the threaded segment, protruding out of the first end, such that the closing ring is hermetically closed on the tube body and is adjacent to the second end.

Other objectives, advantages and novel features of the present invention will become more apparent from the following detailed description when taken in conjunction with the accompanying drawings.

### BRIEF DESCRIPTION OF THE DRAWINGS

FIG. 1 is a side view in partial section of a preferred embodiment of a valve stem core module in accordance with the present invention;

FIG. 2 is an exploded side view in partial section of the valve stem core module in FIG. 1; and

FIGS. 3 to 7 show operational side views in partial section of the valve stem core module in FIG. 1.

### DETAILED DESCRIPTION OF PREFERRED EMBODIMENT

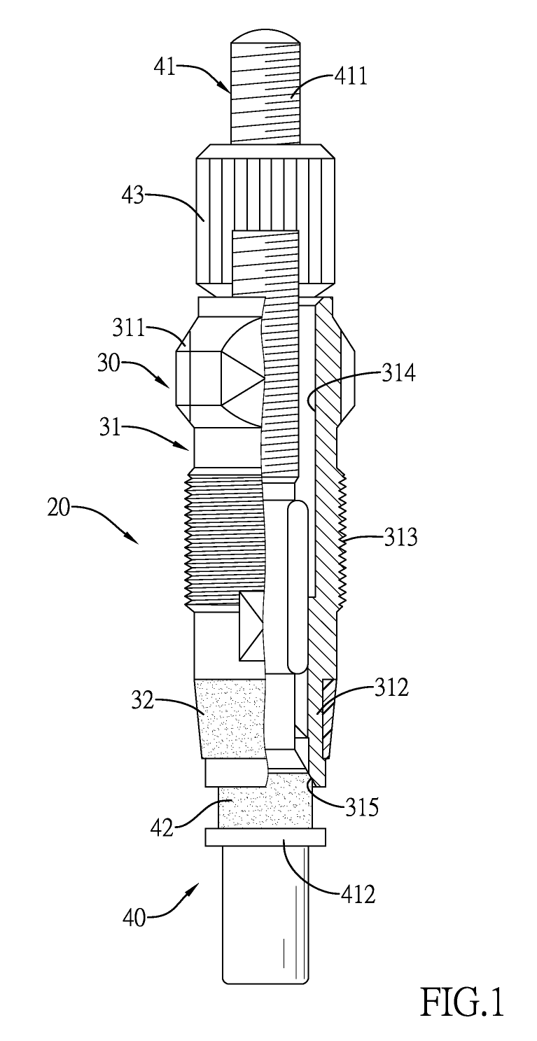

With reference to FIG. 1, a preferred embodiment of a valve stem core module 20 in accordance with the present invention comprises a core tube 30 and a core pin 40.

The core tube 30 comprises a tube body 31 and an airtight ring 32. The tube body 31 comprises a first end 311, a second end 312, a mid segment 313, a body space 314 and a tapered surface 315. A thread is formed on an outer side of the first end 311. The first end 311 and the second end 312 are opposite each other. The mid segment 313 is located between the first end 311 and the second end 312. A thread is formed on the mid segment 313. The thread of the mid segment 313 matches a specification of 5V1 thread. The body space 314 is longitudinally formed through the tube body 31, such that the body space 314 can provide an assembling depth for the core pin 40. The airtight ring 32 is hermetically mounted around an outer side of the second end 312. The tapered surface 315 is formed on an inner side of an opening of the second end 312.

The core pin 40 comprises a pin body 41, a closing ring 42 and a fixing nut 43. The pin body 41 comprises a threaded segment 411 and a positioning portion 412. The closing ring 42 is hermetically mounted around the positioning portion 412. The fixing nut 43 is combined with the threaded segment 411. The pin body 41 of the core pin 40 is inserted into the body space 314. The threaded segment 411 protrudes out of the first end 311. The positioning portion 412 protrudes out of the second end 312, and the pin body 41 is fixed in the tube body 31 by the fixing nut 43, such that the closing ring 42 is hermetically closed by the tapered surface 315.

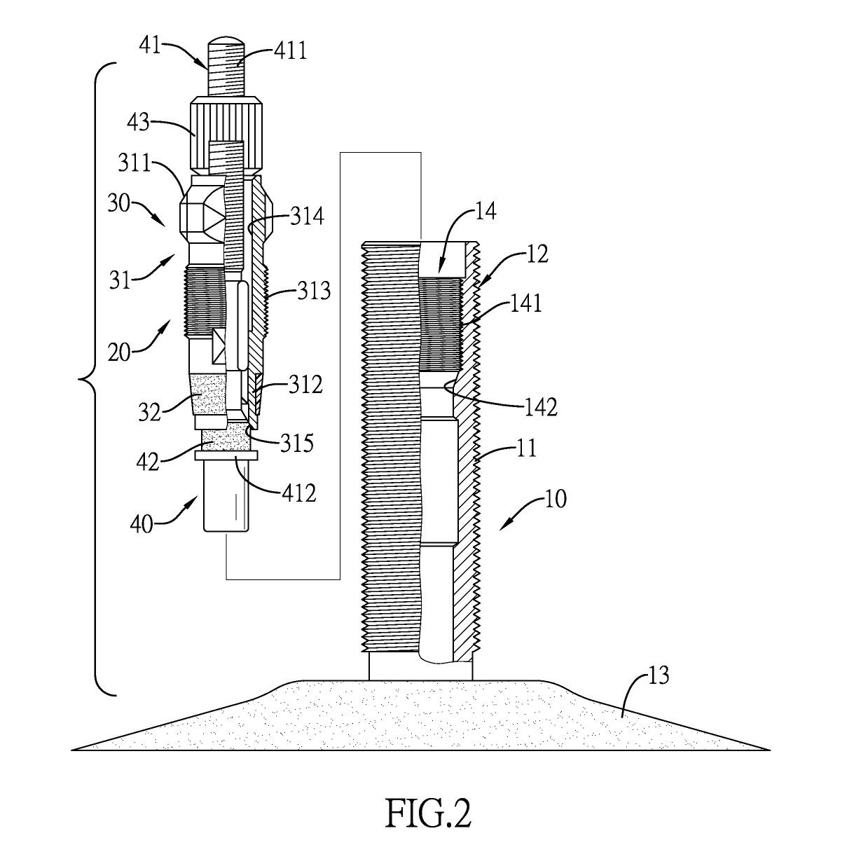

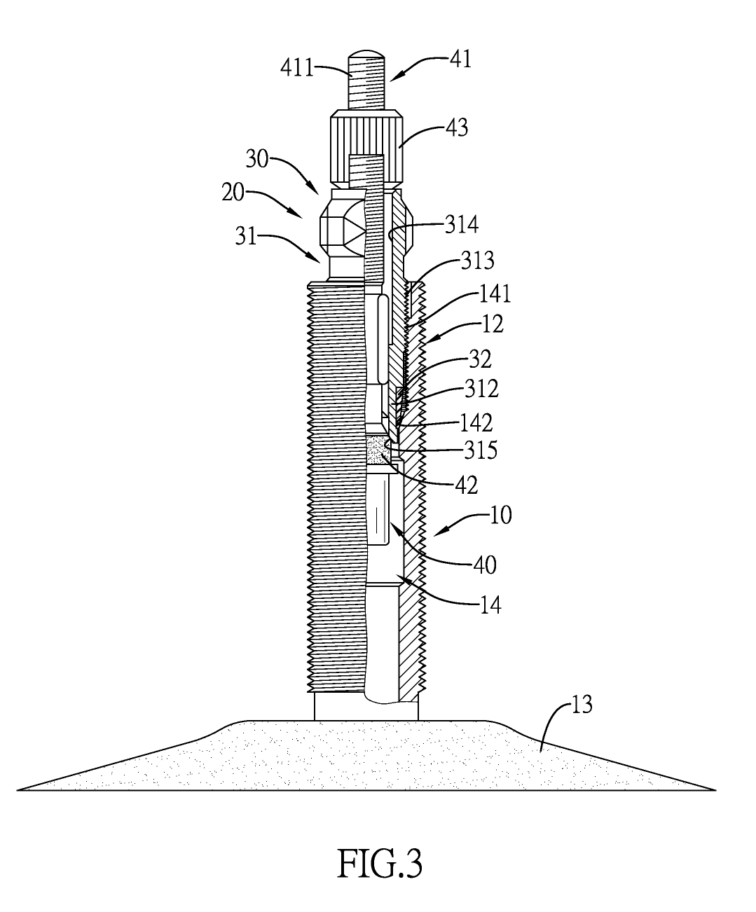

With reference to FIGS. 2 and 3, the valve stem core module 20 is mounted in a Schrader valve stem body 10. A thread 11 is formed around an outer side of the Schrader valve stem body 10. The Schrader valve stem body 10 comprises an assembling end 12 formed on an end of the Schrader valve stem body 10, a through space 14 longitudinally formed in the Schrader valve stem body 10, and a base 13 connected with a bottom of the Schrader valve stem body 10. The through space 14 comprises a combining segment 141 having a specification of 5V1 thread, and a conical segment 142. The combining segment 141 and the conical segment 142 are located on an inner side of the assembling end 12. The combining segment 141 is adjacent to a top of the Schrader valve stem body 10. A diameter of the conical segment 142 is decreased from the assembling end 12 to the base 13.

The mid segment 313 is combined with and matches the combining segment 141 of the through space 14 via the 5V1 thread, such that the airtight ring 32 can be mounted in the Schrader valve stem body 10. The airtight ring 32 can hermetically abut the conical segment 142. The first end 311 protrudes out of the assembling end 12.

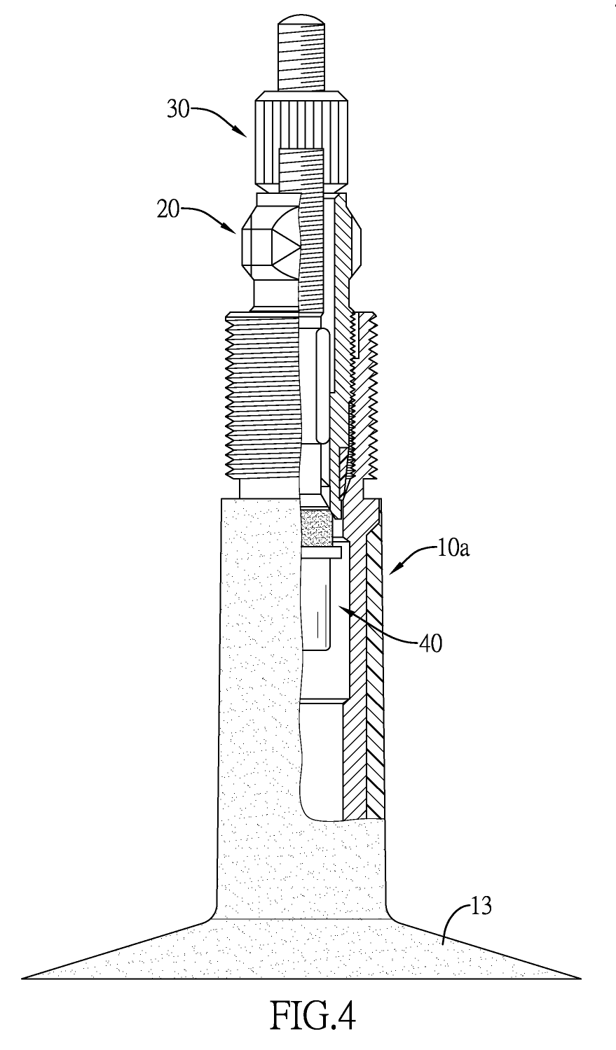

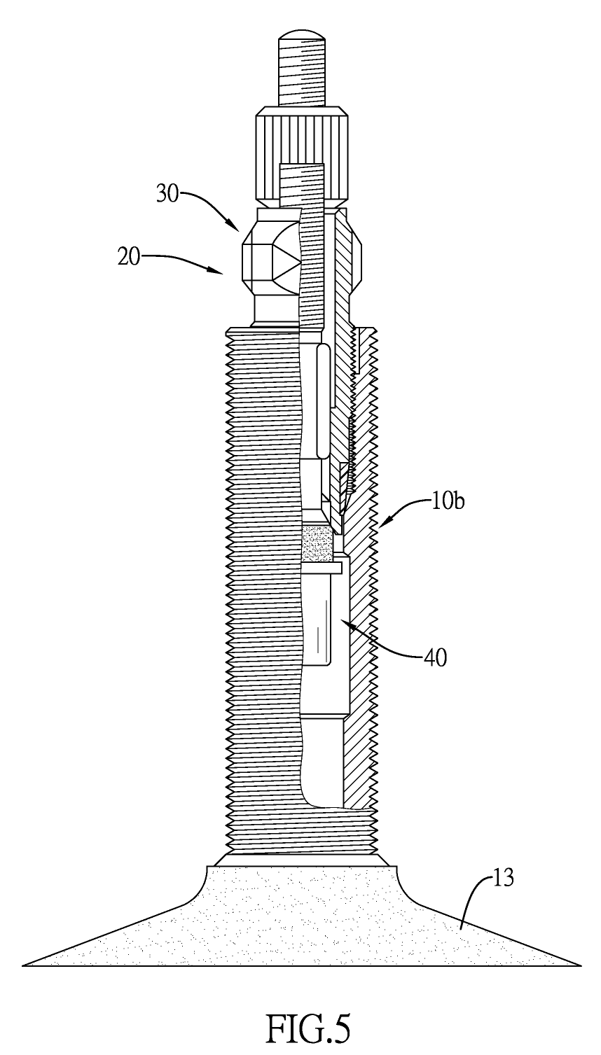

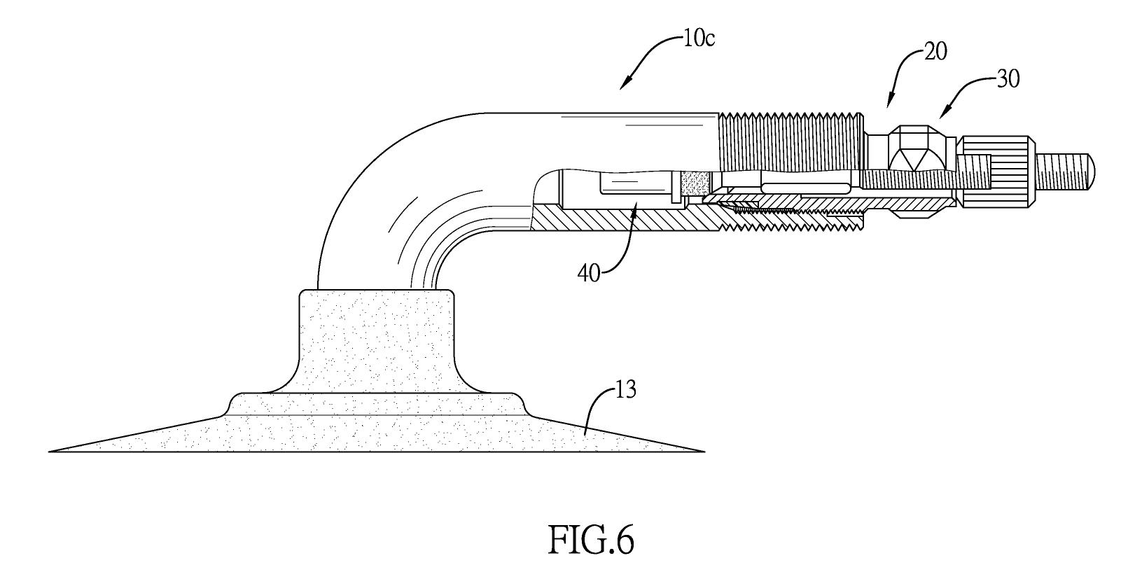

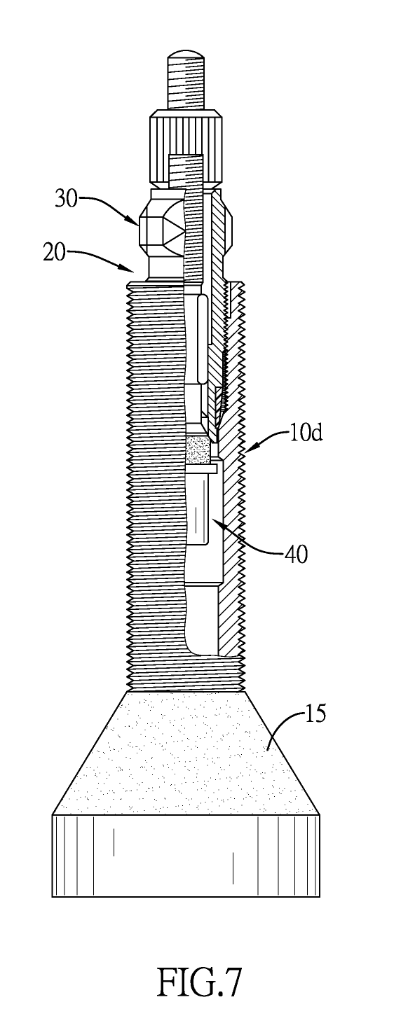

With reference to FIGS. 4 to 7, the valve stem core module 20 can also be mounted in other types of valve stem bodies 10a, 30b, 30c and 30d to form different valve stems. With reference to FIGS. 2 to 6, the base 13 of the valve stem body 10a, 30b, 30c can be fixed on and communicate with an inner tube of a tire. With reference to FIG. 7, a plastic base 15 is mounted on a bottom of the valve stem body 10d. Alternatively, a metal base is mounted on the bottom of the valve stem body 10d, and is fixed on a tire without inner tubes by a nut. Therefore, the valve stem core module 20 can be applied for different valve stem bodies 10a, 30b, 30c and 30d with or without inner tubes.

With reference to FIG. 3, when the tire is inflated, the fixing nut 43 is loosened, such that an interval is formed between the closing ring 42 and the tube body 31. When an inflating device is connected with valve stem body 10, a high pressure air generated from the inflating device is led into the tire through the valve stem body 10. After an inflating process is finished, the inflating device is disassembled, and the fixing nut 43 is re-tightened to keep from leaking. Furthermore, after the inflating process, the core pin 40 is pushed outwardly by the air in the tire, such that the closing ring 42 hermetically abuts the tapered surface 315 to form a leak proof effect even though the fixing nut 43 is loosened.

From the above description, it is noted that the present invention has the following advantages: the valve stem core module 20 can be applied for different valve stem bodies. The valve stem core module 20 can match the specification of 5V1 thread, such that the valve stem core module 20 can be applied for the Schrader valve stem body to have a relatively high strength, such that a life time of the valve stem core module 20 can be improved. Furthermore, the fixing nut 43 is tightened on the pin body 41 to provide the leak proof effect to increase a driving safety.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A valve stem core module comprising:
a core tube comprising
a tube body comprising
a first end, and a thread formed on an outer side of the first end;
a second end opposite to the first end;
a mid segment located between the first end and the second end, and a thread formed on an outer side of the mid segment, wherein the thread of the mid segment matches a specification of 5V1 thread;
a body space longitudinally formed through the tube body; and
an airtight ring hermetically mounted around an outer side of the second end; and
a core pin comprising
a pin body inserted into the body space and comprising a threaded segment and a positioning portion;
a closing ring hermetically mounted around the positioning portion; and
a fixing nut combined with the threaded segment, protruding out of the first end, such that the closing ring is hermetically closed on the tube body and is adjacent to the second end.

2. The valve stem core module as claimed in claim 1, wherein the tube body further comprises a tapered surface formed on an inner side of the second end.
